(19) United States
(12) Patent Application Publication
(10) Pub. No.: US 2009/0055157 A1
(43) Pub. Date: Feb. 26, 2009

(54) Server Having Remotely Manageable Emulated Functions

(75) Inventor: Aviv Soffer, Geva Carmel (IL)

Correspondence Address: Eckert Seamans Cherin & Mellott, LLC, U.S. Steel Tower, 600 Grant Street, 44th Floor, Pittsburgh, PA, 15219, US

(73) Assignee: Beyond Blades Ltd.

(21) Appl. No.: 12/197,532

(22) Filed: Aug. 25, 2008

Related U.S. Application Data
(60) Provisional application No. 60/957,521, filed on Aug. 23, 2007.

(51) Int. Cl. G06F 9/455

(52) U.S. Cl. 703/27

(57) ABSTRACT

A new and unique server having server core, storage interface I/O function, local area network interface I/O function that comprises remote graphic controller manageable emulated function (RMEF). The RMEF comprises circuitry capable of emulating a standard graphic controller to the server core so as to enable the core to generate video frames and circuitry capable of remotely delivering the video frames to remote management console application and other I/O interface functions. The functions can be implemented on a single chip.

### FIELD OF THE INVENTION

The present invention relates in general to a server architecture intended to emulate and replace various legacy functions and chips to provide plurality of simulated remotely managed functions such as Keyboard Video Mouse (KVM) over IP for remote management and BIOS.

### BACKGROUND OF THE INVENTION

Modern servers are critical component of any modern IT system. Enterprise class servers are hardly being used toady as a conventional computer connected locally to display, keyboard and mouse. Typical application for such server requires remote access for the administrator through a KVM (Keyboard Video Mouse). This access is typically limited for initial installation, maintenance, monitoring and trouble-shooting of the server.

In larger sites where one administrator need to manage many servers or when servers are co-located at remote sites a KVM over IP function can be added to the servers to enable remote management of multiple servers from remote computer.

This type of use requires double conversion of various functions from the digital domain to the physical domain (or User Interface) and back to the digital domain—for example: digital video image is generated in an on-board video controller, and then the image is converted into an analog video signal. Then this analog video signal is sampled by an Analog to Digital converter in the attached KVM device or management card. The sampled digital stream is then compressed, routed to the remote administrator location where it is converted again to analog signal for the administrator display.

This double conversion process suffers from several significant disadvantages:
1. It takes large real-estate area on the server board
2. It consumes power and dissipates heat
3. It reduce the video signal quality
4. It requires additional (external or internal) KVM function
5. Higher components costs
6. It is typically hard-wired to the platform and therefore it is not modifiable by software
7. Typically there is no common console to manage many servers and there is no simple way to manage servers using structured policy at the lowest level—boot and BIOS (Basic Input Output System).

Remote management of the BIOS (Basic Input Output System) is another problem exists in current servers. At the early days of the PC, the BIOS was extensively used to initiate the platform and its connected peripherals. Later the value of the BIOS reduced as PC operating systems took many of the early functions of the BIOS. In recent years as multiple core servers and blade architecture evolved, the BIOS role becomes significant again. In current enterprise servers the BIOS responsible for much complex platform initialization, security, health monitoring, power management, thermal management, multi-processor configuration, processors and busses initialization and many other roles.

Hence BIOS settings and upgrades become more important for servers and BIOS centralized management becoming more challenging.

The current invention intended to replace least two of the above mentioned real functions by providing a server function that emulates the exact or similar behavior of these functions to the server cores, but on the same time designed in a way that enables simple remote management over LAN or WAN. These functions defined hereafter as Remote Manageable Emulated Functions or RMEF.

One significant advantage of the architecture of the server of the present invention is that since real functions are emulating the behavior of similar functions in a standard x86 or 64 bit PC architecture, this architecture enabling minimal or no changes in the Operating system and the applications installed on such server.

The design of such RMEF follows the following general guidelines:

RMEF design aspects from the front side (server cores):
1. The RMEF replaces and emulates all usable functions in the original architecture as defined by legacy hardware vendors, industry standards and by compatibility requirements for popular Operating systems such as Microsoft, Linux, VMware etc.
2. RMEF contains similar registers and I/O space mapping and is therefore visible to the OS and applications as the real function.
3. RMEF may contain a superset or a subset of the legacy real functionality but the implementation should not affect standard OS and application compatibility.
4. RMEF should retain its functionality in the case that management LAN or remote management console/application is not available.
5. RMEF is capable to restore to factory defaults at initial operation or if instructed by remote management console/application.
6. RMEF may be implemented with internal buffering to assure proper flow of transmitted and received traffic between the emulated function and the remote management console/application.

RMEF design aspects from the back side (management LANNVAN):
1. RMEF reports all possible function settings and statuses to the remote management console/application.
2. RMEF enables server authentication, administrator authentication and management console/application authentication to assure proper security level.
3. RMEF enables loading of settings and software from the remote site to the server to operate and configure that function.
4. Data transfer between the management console/application and the RMEF may be compressed to reduce bandwidth utilization.
5. Data transfer between the management console/application and the RMEF may be encrypted to increase data security.

The server of the present invention may be implemented using emulated functions (RMEF) to replace all real functions other than the cores and the physical function (power, cooling etc.)

For example, the following real functions may be replaced by Remote Manageable Emulated Functions (RMEF) as part of the server apparatus of the present invention:
BIOS ROM and address decoding
Video controller
Keyboard controller or USB host controller
Mouse controller or USB host controller
USB host controller
Interrupt controller
DMA controller
Storage controller (IDE, EIDE, SATA, SCSI, FC etc.)
LAN controller (primary/secondary)
Real Time Clock function
CMOS RAM function
Legacy PCI, PCI-X and PCI Express controllers
System controller
System Management Bus controller
Physical sensors (thermal, others) interfaces
Reset circuitry
Power supplies control and monitoring circuitry
Server cores clock management circuitry
Watchdog circuitry, TCO reduction circuitry
Management LAN function
Hyper-Transport cave function
Memory controller initialization memory
Cooling system control
Audio CODEC
Event timers
Topology detection and configuration
Health monitoring, history, hardware events logging
Tampering sensors

The benefits of such server architecture:
Simple and efficient server virtualization
Management of low-level functions through remote centralized applications
Easy BIOS and system management upgrade
Reduced heat and power consumption
Highly automated system installation
Server always manageable over LAN—server can be reset and monitored even when it is powered off
Minimum board space utilized for functions other than the cores.
Detailed platform health monitoring functions
High management security
Easy system recovery
Standardization across different server topologies and scales
Lower server costs
Higher server reliability
Cross vendors compatibility (between Intel and AMD for example)
Reduced platform development complexity

No need for management cards, modules or external KVMs

### REFERENCED PATENTS

U.S. Pat. No. 7,003,607, Gulick. Feb. 21, 2006, Managing a controller embedded in a bridge
U.S. Pat. No. 6,070,253, Tavallaei, et al. May 30, 2000, Computer diagnostic board that provides system monitoring and permits remote terminal access
U.S. Pat. No. 7,032,108, Maynard, et al. Apr. 18, 2006, System and method for virtualizing basic input/output system (BIOS) including BIOS run time services
U.S. Pat. No. 7,000,101, Wu, et al. Feb. 14, 2006, System and method for updating BIOS for a multiple-node computer system
U.S. Pat. No. 6,701,380, Schneider, et al. Mar. 2, 2004, Method and system for intelligently controlling a remotely located computer
U.S. Pat. No. 6,324,644, Rakavy, et al. Nov. 27, 2001, Network enhanced bios enabling remote management of a computer without a functioning operating system
U.S. Pat. No. 7,136,946, Shirley. Nov. 14, 2006, Packet-based switch for controlling target computers
U.S. Pat. No. 6,681,250, Thomas, et al. Jan. 20, 2004, Network based KVM switching system

### SUMMARY OF THE INVENTION

The present invention provides a server architecture and apparatus suitable for virtualization and remote management having one or more emulated functions substituting one or more functions.

With the latest advancements in server virtualization and client virtualization, the role of the enterprise server is shifting toward a highly replicated computational resource. The installation of the virtual server is typically done remotely and in many cases it is automated. The need for local user interface reducing and the need for detailed remote management are becoming more apparent.

The popularity of high-end multiprocessor servers and their use for virtual applications reduce the usability of the platform in a direct connection mode and therefore emulating these direct connection functions provide even better need for the present invention.

### BRIEF DESCRIPTION OF THE DRAWINGS

A better understanding of the present invention can be obtained when the following detailed description of the preferred embodiment is considered in conjunction with the following drawings.

The same reference numbers are used to designate the same or related features on different drawings. The drawings are generally not drawn to scale.

FIG. 1 illustrates a block diagram of a 4-way 64 bit Server or Blade according to the Prior art.

FIG. 2 illustrates yet another block diagram of a similar 4-way 64 bit Server or Blade having a separate management NIC according to the Prior art.

FIG. 3 illustrates yet another block diagram of a similar 4-Way 64 bit Server or Blade having a separate management NIC and a KVM over IP according to the Prior art.

FIG. 4 shows yet another block diagram of a similar 4-way 64 bit Server or Blade having external KVM over IP according to the Prior art.

FIG. 5 illustrates a block-diagram of a 4-Way 64 bit Server or Blade of the present invention.

FIG. 6 illustrates a more detailed block-diagram a server emulated south side sub-system according to the present invention.

FIG. 7 illustrates a potential implementation block diagram of server emulated south side sub-system according to the present invention.

FIG. 8 illustrates another potential implementation block diagram of server emulated south side sub-system having integrated Hyper Transport tunnel, Primary host LAN interface and storage interface according to the present invention.

FIG. 9 shows yet another potential implementation block diagram of server emulated south side sub-system having integrated two Hyper Transport links according to the current invention.

FIG. 10 illustrates a block diagram of an Intel Architecture 32 bit Server or Blade according to the Prior art.

FIG. 11 illustrates a block diagram of an Intel Architecture 32 bit Server or Blade having some managed emulated functions coupled to the ICH chip according to the present invention.

FIG. 12 illustrates a block diagram of an Intel Architecture 32 bit Server or Blade having managed emulated functions integrated with the ICH functionality according to the present invention.

FIG. 13 illustrates a more detailed block diagram of the Video Controller Remote Manageable Emulated Function (RMEF) according to the present invention.

FIG. 14 shows a more detailed block diagram of the BIOS Remote Manageable Emulated Function (RMEF) according to the present invention.

FIG. 15 illustrates a flow chart of managed server power up sequence according to the present invention.

FIG. 16 illustrates a system level block diagram of managed servers connected to local and remote management console according to the architecture of the present invention.

FIG. 17 illustrates a system level block diagram of managed blades or 3DMC servers.

### DETAILED DESCRIPTION OF PREFERRED EMBODIMENTS

In the following detailed description, numerous details are set forth in order to provide a thorough understanding of the present disclosed subject matter. However, it will be understood by those skilled in the art that the disclosed subject matter may be practiced without these specific details. In other instances, well-known methods, procedures, components, and circuits have not been described in detail so as to not obscure the disclosed subject matter.

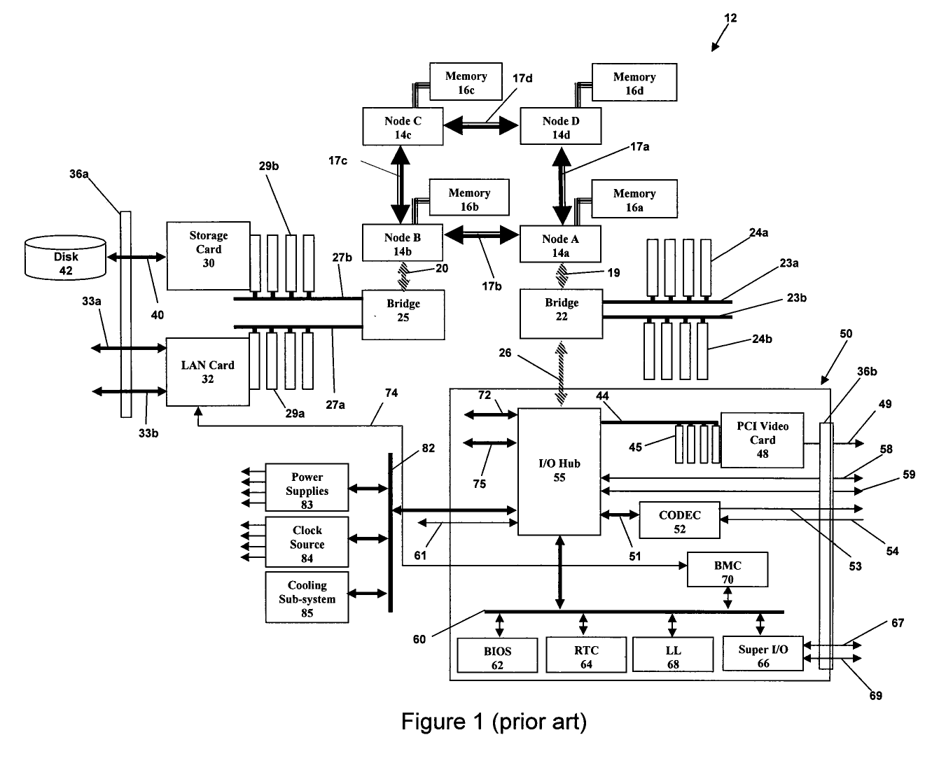

FIG. 1 illustrates a typical prior-art 64 bit server or server blade 12 simplified block diagram having 4 identical processor nodes 14a, 14b, 14c and 14d, each with a separate memory bank 16a, 16b, 16c and 16d respectively. In this example, the nodes are AMD 64 bit processors each with an integrated cache, memory controller and 3 HyperTransport buses. Nodes are connected together by coherent Hyper Transport buses 17a, 17b, 17c and 17d.

Coherent HyperTransport buses enable shared cache content access between the 4 nodes.

Non-coherent HyperTransport bus 19 extends from Node A—14a through HyperTransport bridge 22 and from there through HyperTransport bus 26 to the HyperTransport cave at the I/O Hub 55. The said bridge 22 bridges between the passing HyperTransport bus and PCI-X or PCI Express busses 23a and 23b connected to open PCI-X or PCI Express slots 24a and 24b respectively. This arrangement enables assembly of various standard PCI-X or PCI Express cards for data communications with the cores (for example Fiber Channel, SCSI, RAID, Video and LAN cards).

The PCI-X or PCI Express Buses 23a and 23b are 64 bit buses running at clock rates that may vary from 66 MHz single clock to 133 MHz quad clock (533 MHz) delivering data throughputs of 533 MB/s to 4.26 GB/s.

This type of HyperTransport structure called I/O Chain. This I/O Chain is originated in the HyperTransport bridge at Node A 14a, passed through the PCI-X or PCI Express bridge 22 and terminates at the HyperTransport Cave in the I/O Hub 55.

Similar non-coherent structure extends from Node B 14b through HyperTransport bus 20 to HyperTransport bridge 24 where this I/O chain terminates.

The said bridge 24 bridges between the HyperTransport bus and PCI-X or PCI Express busses 27a and 27b connected to PCI-X or PCI Express slots 29a and 29b respectively. This arrangement enables assembly of various standard PCI-X or PCI Express cards for data communications with the cores (for example storage interface cards such as Fiber Channel, SCSI and RAID, Video and LAN cards etc).

In this particular example PCI-X or PCI Express slots 29a are populated by a dual Local Area Network PCI-X or PCI Express card to enable connection of the server 12 to 2 LAN 33a and 33b. These LAN connections may be Giga bit per second or faster and it is extended from the server enclosure or blade trough set of connectors 36a.

Similarly PCI-X slots 29b are populated by a PCI-X or PCI Express storage interface card 30 to enable connection of a storage disk, array or other storage appliance 42 to the server 12. This storage interface is connected via bus 40 that may be SCSI, IDE, SATA, Fiber Channel or any other storage communications protocol. It may be extended outside the server 12 enclosure or blade through set of connectors 36a to interface with external storage resources.

The following text further explains the server 12 South side sub-system 50.

This sub-system is responsible for various secondary functions such as BIOS, Real-Time-Clock, slower peripherals interface and power management. Hyper-Transport bus 26 terminates in the I/O Hub block 55 where certain slower functions are interfaced. These functions may include:

Legacy PCI bus 44 having legacy PCI slots 45. In this example one of these PCI slots 45 is populated by a PCI video card 48. Generated video signals 49 extend from the server 12 enclosure or blade through set of connectors 36b. Legacy PCI bus is 32 bit width and may run at 33 or 66 MHz. PCI bus arbiter function contained in the said I/O Hub block 55. As servers typically do not require high video performance, a legacy PCI card 48 may be sufficient and cost effective compared to a faster PCI-X or PCI Express card needed for multimedia and gaming PC applications.

Audio CODEC 52 is coupled to the I/O Hub 55 by a serial AC-Link bus 51. The audio out signals 53 and the audio in signals 54 extend from the server 12 enclosure or blade through set of connectors 36b. CODEC may be AC '97 2.2 or any other standard with 2, 4, 6 or more audio channels. Typically enterprise servers do not require a high-quality audio CODEC as they are hardly used for local multimedia applications.

USB host controllers resides inside said I/O Hub function 55 (not shown here) and USB signals 58 and 59 extend from the server 12 enclosure or blade through set of connectors 36b. USB is typically used to connect a keyboard and mouse to the server though USB interface is typically USB 2.0 standard to enable connection of faster USB storage devices as well. The USB host controllers are typically interfacing with the system through the internal PCI bus. These USB controllers are typically comprises of Enhanced Host Controller (EHC) to handle the USB 2.0 high speed traffic, and one or more OHCI (Open Host Controller Interface) compliant host controllers to handle all USB1.1 compliant traffic and the legacy keyboard emulation (for non-USB aware environments). It also may comprise of a Port Router block to route the various host controller ports to the proper external USB ports.

The I/O Hub 55 typically contains System Management Bus (SMBus) host controller/s function to communicate with external system resources. SMBus 82 enables monitoring and control of various system resources such as power supplies 83, system clocks source 84 and various cooling functions 85. The supported SMBus protocol may be 1.0, 2.0 or any other usable protocol.

In addition to the SMBUS interface described above, certain discrete/PWM system functions are managed or monitored by the I/O Hub 55 through General Purpose Input/Output (GPIO) and Pulse Width Modulation (PWM) signals 61. Discrete signals may be used to monitor server AC power availability, CPUSLEEP and CPUSTOP signals to command certain CPU low power states, FANRPM and FANCONTROL to monitor and control cooling fans, PWROK signals from power supplies, Thermal warning detect input, Thermal trip input etc. PWM signals can be used to drive cooling fans and pumps at various speed as needed by the system.

Discrete I/Os 61 may also include legacy PC signals such as legacy interrupt inputs (IRQ1 to IRQ15), Serial IRQs, Non Mask able Interrupt (NMI), Power Management Interrupts, Keyboard A20 Gate signal etc.

Low Pin Count (LPC) bus 60 extends from the said I/O Hub 55 to interface with slower and legacy peripheral functions such as:

BIOS ROM/Flash 62 that is being used for server booting. The code residing in this memory space is used to initialize and boot the boot node (Node A in this example). After boot node initialization, same code is used to boot the other 3 nodes through the HyperTransport Coherent busses.

RTC (Real Time Clock) function 64 that provides the server with accurate date and time information. The RTC function is typically backed-up by a small battery to maintain accurate time even when the server is powered off. RTC function also typically includes a 256 bytes of CMOS, battery-powered RAM to store legacy BIOS settings and ACPI-compliant extensions.

Legacy Logic functions 68 comprising of various legacy x86 functions to assure compatibility with software and operating systems. These functions typically include:
Legacy 8254/8259 compatible Programmable Interrupt Controller (PIC) to support vectored interrupts INTR, ExtINT and lowest priority non-vectored interrupts NMI, SMI and INIT. These interrupts are passed through routing equations the IOAPIC/X-IO APIC and then sent through HyperTransport messages on HyperTransport bus 26 and 19 to the proper host node 14a, 14b, 14c, 14d for handling.
IOAPIC function to route the various interrupts generated by said legacy PIC, PCI interrupts, GPIOs, SMBUS and internal I/O Hub logic thorough the HyperTransport bus to the host nodes.
Dual cascaded legacy 8237 compatible DMA controllers supporting PCI to PCI DMA, LPC DMA and Type F DMA
PORTCF9 reset logic
PORT61 and PORT92 legacy registers
FERR_L and IGNNE interrupt logic
PORT4D0 legacy interrupt edge-level select logic
One or more 8254 compatible Programmable interval timer (PIT)
High Precision Event Timer (HPET)—typically consists of a block of three timers. This block contains a 32-bit up counter with three 32-bit output comparators each for one timer. Timer 0 can operate in either periodic or non-periodic mode, timer 1 and 2 only in non-periodic mode.
Watchdog Timer (WDT)—a down counter starting at a programmed value. It resets or shuts down the system if the count reaches zero. Operating system services periodically restart the timer so that if the operating system, drivers or services stop functioning, the system is automatically restarted or shut down.

Legacy Logic 68 circuitry may be physically located in the I/O Hub function 55. Super I/O 66 used to add external legacy interfaces such as serial port 67, parallel port 69 or PS/2. These interfaces are hardly in use today in typical enterprise server applications.

Optional Baseboard Management Card (BMC) 70 to enable remote server management and monitoring through the standard LAN ports 33a and 33b. BMC 70 is coupled to the LAN card 32 through “side band” connection using I2C or SMBus link 74.

BMC management function typically operates by industry standards such as IPMI 2.0 and Open Platform Management Architecture (OPMA). Such BMC 70 supports hardware monitor for the host CPUs, various system temperature, system fan & CPU fan status, system voltage. It usually supports Event Log information for hardware monitor events. As this function is typically powered by the always-on standby power plan, it supports remote management when system dead or in power standby mode. It enables remote power control through OS to perform Shutdown, Reboot and Power cycle. It also may control directly through buttons on system chassis of functions such as Reset, Power down, Power up and Power cycle. BMC also supports SNMP trap (multiple destinations), Console Redirection (text only) through LAN (SOL—Serial Over LAN) and User, password security control.

The I/O Hub 55 may also include an Ethernet controller function to interface with external LAN 72 and an integrated EIDE or SATA storage interface to enable direct connection of a hard-disk through the connected bus 75. The LAN MAC is typically interfacing with the system through the internal PCI bus. Typically it requires external Physical Layer circuitry to interface with the LAN cable 72.

The I/O Hub 55 functions may include System Power State Controller (SPSC) to enable power planes and CPU management at various power states. Through thermal sensors and cooling system 85 monitoring, operating system and BIOS may regulate various CPU power states and change power supply 83 and clock source 84 settings accordingly.

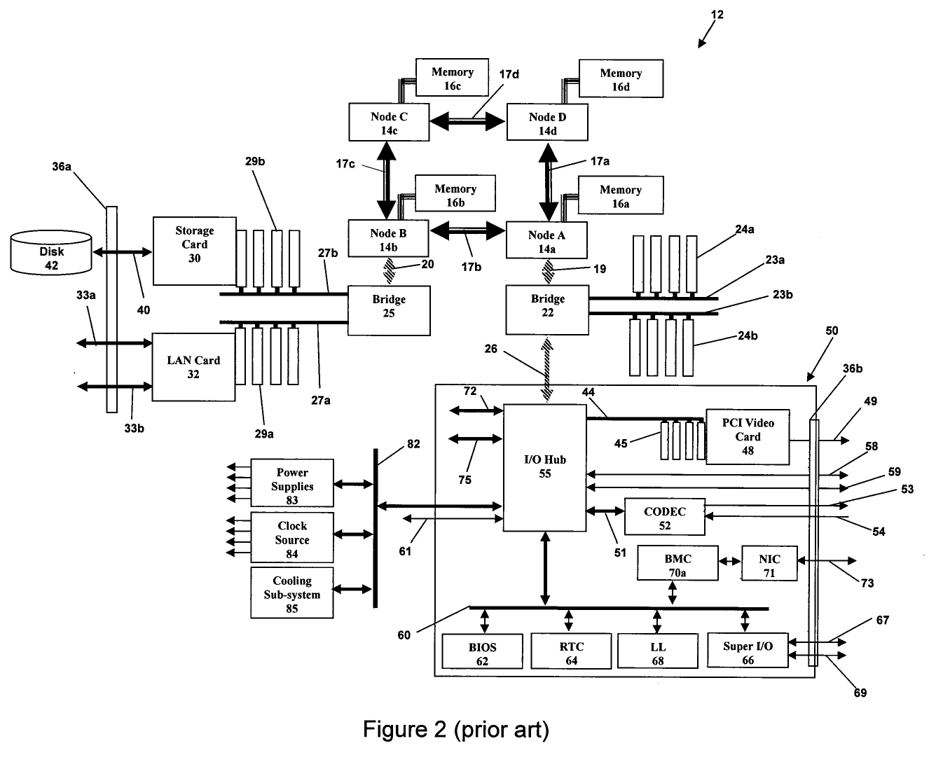

FIG. 2 is a similar prior art 4-way server block diagram as in FIG. 1, this server implementation further comprising of a Baseboard Management Card (BMC) 70a coupled to a separate Network Interface Card (NIC) to interface the system with an external management network 73. This server implementation provides higher management functionality, security and typically enables access to hardware health data through BMC-based web server. BMC may also function as a Remote virtual mass-storage to enable remote installation of operating system and applications. BMC typically comprises of small RISC processor, memory and flash to implement industry standard protocols, security and session access.

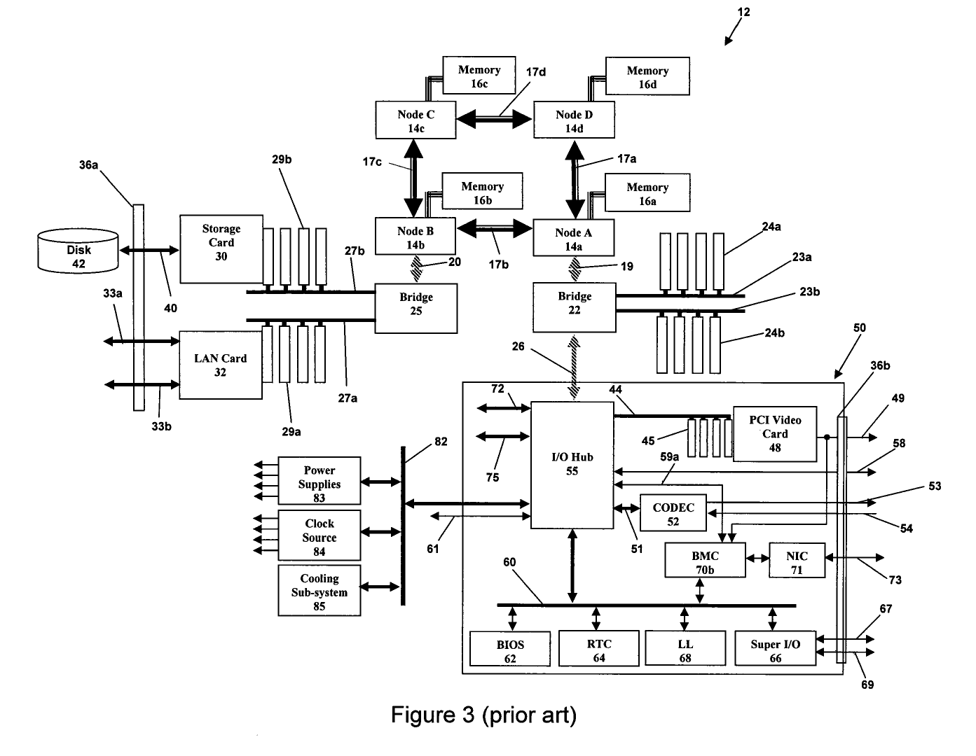

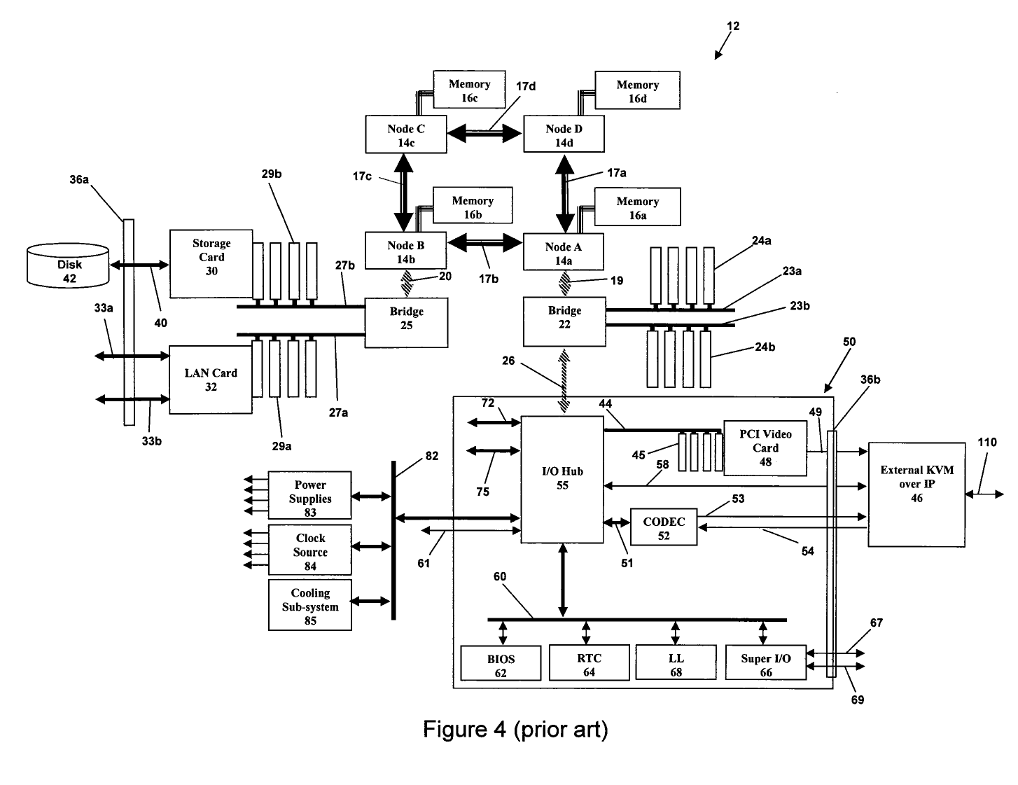

FIG. 3 is a similar prior art 4-way server block diagram as in FIG. 1, this server implementation further comprising of a Baseboard Management Card (BMC) 70b coupled to a separate Network Interface Card (NIC) to interface the system with an external management network 73. BMC function 70b further coupled through the system video out port 49 to the video controller or card 48. BMC is further coupled to the one of the system USB ports 59a. Video out analog signal is sampled by an Analog to Digital converter in the BMC 70b and sent to remote locations through KVM over IP functionality. If video is DVI then a DVI receiver in the BMC 70b converts the LVDS signals into digital levels and then send the resulted stream into the management LAN port 73 to the remote management station. USB signals are also transferred by the BMC circuitry to the remote management location where USB devices are physically connected. BMC 70b may be implemented as soldered-down function on the motherboard, as an optional module or as an external module as shown in FIG. 4.

FIG. 4 is the same prior art 4-way server 12 block diagram as in FIG. 3 but in this implementation an external KVM over-IP device 46 is connected to the server video output 49, server USB port 58, server audio out 53 (optional), and server audio in 54 (optional). Management LAN 110 also connected to the device 46 to enable remote management of that server. The power needed for the external KVM device 46 may be supplied by the server or may be supplied by externally connected power supply.

It should be noted that this typical implementation is popular as it does not require any internal installation and hardware and it is not depending on server software or power. Still it suffers from many disadvantages such as added cost, size and from the degraded monitoring and control functionality compared to internal BMC module.

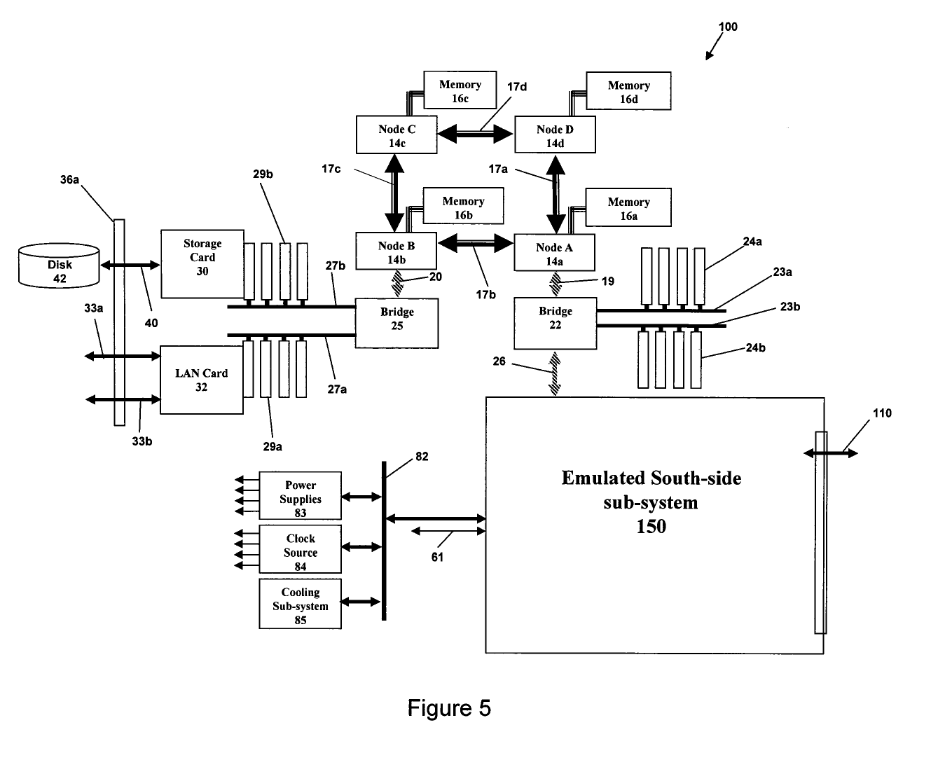

FIG. 5 is a functional block diagram of an exemplary 4-Way server system, including the south-side emulator sub-system, for practicing the current invention;

This figure illustrate a block diagram of a similar 4-way server 100 as in FIG. 1 wherein in this server implementation the south-side emulator sub-system 150 of the present invention replaces the South-side sub-system 50 of FIG. 1 above.

In this embodiment of the present invention, the functions contained in the conventional South side sub-system are fully replaced by Remotely Manageable Emulated Functions (RMEF) to emulate same operational functions to the host side and therefore enable operating system and software commonality with prior-art servers.

The only user interaction in this implementation is done remotely thorough the management LAN port 110 extending from the server enclosure or blade 100. Internal interfaces such as HyperTransport bus 26 interface, SMBUS 82 interface and discrete/PWM I/O 61 are identical to the prior-art server implementation shown in FIG. 1.

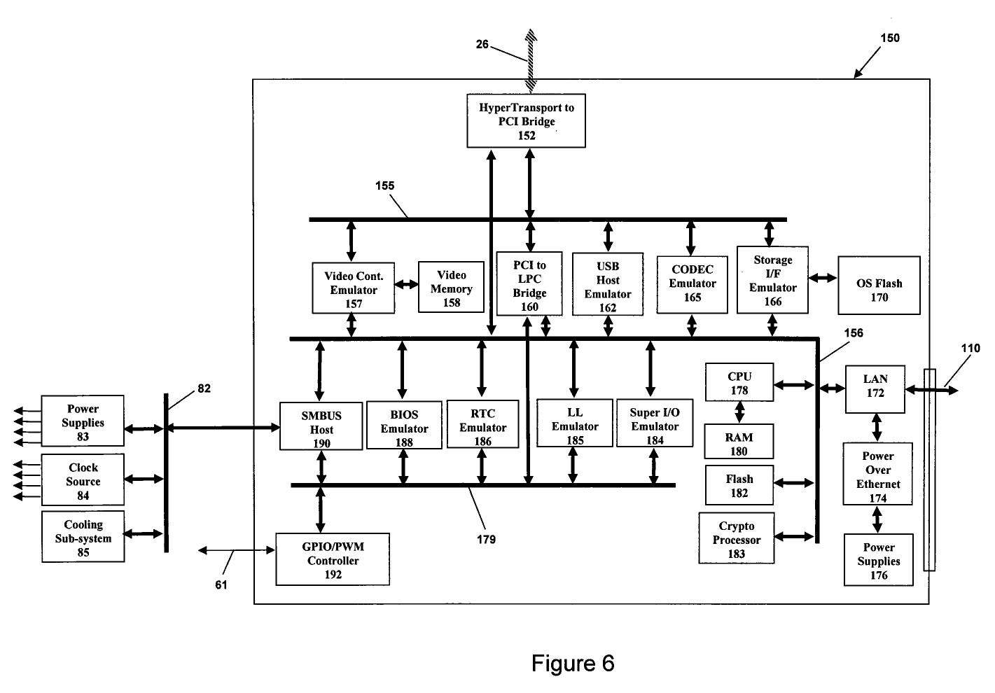

FIG. 6 illustrate an expanded block diagram of the Emulated south-side sub-system 150 of the 4-way server 100 shown in the previous figure.

The Hyper-Transport to PCI bridge 152 serves as an interface between the faster HyperTransport bus 26 and the slower internal PCI bus 155. In typical implementation the HyperTransport to PCI bridge 152 is capable of linking with the host at rates of 400 Mbps at each direction (aggregated bandwidth of 800 Mbps). This bandwidth is limited in time as the connected busses are much slower and therefore cannot handle traffic to or from the host at such high bandwidth. The HyperTransport to PCI bridge 152 is also connected to the Internal Management Bus (IMB) 156 to enable BIOS and remote management functionality. Typical functionality includes the configuration and assignment of HyperTransport protocol Unit ID for the various emulated functions connected to the PCI bus 155.

Video Controller RMEF 157 is similar to the real (prior art) video controller 48 shown in FIG. 1 but it is adapted specifically for remote use through an integrated KVM function. This RMEF typically contains the standard 2D video engine and registers and video memory controller but does not contain display interface modules as it does not have a local physical interface for display. The Video Controller RMEF 157 circuitry is therefore connected to the host side through the internal PCI bus 155 and to the remote management functions through IMB 156. The Video Controller RMEF 157 also connected to the video memory function 158 that serves as a frame buffer memory to store video frames drawn by the video controller engine or transferred through Direct Memory Access (DMA) transactions. The generated video frames are read and transferred to the IMB 156 through the memory controller inside the Video Controller RMEF. Video Controller RMEF may also comprise of a video frame compression function to compress the video frames read from the video memory 158. This compression reduces the traffic on the IMB 156 and on the management network 110.

The PCI to LPC bridge 160 function is similar to the PCI to LPC bridge 60 shown in FIG. 1. This bridge interfaces between the internal PCI bus 155 and the internal LPC bus 179 to support slow functions such as BIOS 188 and RTC 186. The PCI to LPC bridge 160 function also connected to the IMB 156 to enable management and monitoring.

The USB Host Controller RMEF 162 connected to the internal PCI bus 155 similar to the real USB Host controller function in the I/O Hub 55 of FIG. 1. The USB Host Controller RMEF 162 also interfaces with the IMB 156 to enable remote connection of various USB devices such as keyboard, mouse, CD drive and USB flash device. The interface with the IMB 156 delivers the USB data to and from the remote connected USB peripherals through the Management LAN 110.

The Audio Codec RMEF 165 connected to the internal PCI bus 155 similar to the real Audio Codec function in the I/O Hub 55 of FIG. 1. The Audio Codec RMEF 165 also interfaces with the IMB 156 to enable remote streaming of digital audio to and from the platform. The interface with the IMB 156 enables digital audio streams to be delivered to remote locations through the Management LAN 110. It should be noted that this RMEF may not be required for typical server applications as audio interaction is not being used.

The Storage Interface RMEF 166 connected to the internal PCI bus 155 similar to the real Storage controller function in the I/O Hub 55 of FIG. 1. The Storage Interface RMEF 166 also interfaces with the IMB 156 to enable remote configuration, monitoring and data transfers to and from remote storage. The interface with the IMB 156 delivers the storage data to and from the remote connected storage through the Management LAN 110. Optional local OS flash 170 enables local OS boot using the Storage Interface RMEF 166. The Storage Interface RMEF 166 may emulate plurality of storage devices such as IDE, SCSII, SATA and Fiber Channel.

The SMBus host function 190 is similar to the SMBus host function in the I/O Hub 55 of FIG. 1. This function connected to the internal LPC bus 179 to enable control and monitoring of various platform resources connected to the SMBus 82. The SMBus host function 190 is also interfaces with the IMB 156 to enable remote configuration, monitoring and control of connected resources such as power supplies 83, clock source 84 and cooling sub-system 85.

The GPIO/PWM Controller RMEF 192 is similar to the real GPIO/PWM Controller function in the I/O Hub 55 of FIG. 1. This RMEF connected to the IMB 156 to enable local and remote configuration, monitoring and control of connected discrete resources such as host CPU ACPI signals, cooling system signals and error signals. Various system health and operational parameters can be monitored through SMBus and GPIO/PWM Controller RMEF 192, these parameters can be monitored remotely through the management LAN 110 and remote management console/application. In a similar way various actions may be activated remotely by the management console/application to enable remote reset, power recycling, power on etc. Remote management console/application connected to the management LAN 110 can command such actions through the management CPU 178 and the IMB 156. Discrete output signals are generated by the GPIO/PWM Controller RMEF 192 coupled to the proper system functions.

The BIOS RMEF 188 connected to the internal LPC bus 179 similar to the real BIOS function 62 shown in FIG. 1. The BIOS RMEF 188 connected to the internal LPC bus to enable BIOS code execution by the hosts. The BIOS RMEF 188 also interfaces with the IMB 156 to enable remote boot, BIOS loading, configuration, monitoring remotely. The interface with the IMB 156 enables management access to the BIOS RMEF memory media 260. This memory media 260 may be RAM, SRAM, dual port RAM, flash or any other suitable memory media. During boot the boot host node executes BIOS read transactions from the BIOS RMEF media 260 through the HyperTransport link 26, the HyperTransport to PCI bridge 152, the PCI to LPC bridge and 160 and the LPC bus 254.

System setup and BIOS configuration can be loaded and manipulated remotely thorough a centralized management application. Interfaces with LDAP structures enable policy based management of server platforms.

The RTC RMEF 186 connected to the internal LPC bus 179 similar to the real RTC function 64 shown in FIG. 1. The hosts can access the legacy RTC registers located in this RTC RMEF to receive time and day information. The RTC RMEF can also generate interrupts at constant time intervals and alarms at preset elapsed timings. The emulated RTC function 186 also interfaces with the IMB 156 to enable remote clock setting and synchronization remotely without local battery. The interface with the IMB 156 enables management access to the RTC RMEF registers.

The Legacy Logic (LL) RMEF 185 is connected to the internal LPC bus 179 similar to the real LL function 68 shown in FIG. 1. The LL RMEF 185 also interfaces with the IMB 156 to enable local and remote setting and configuration.

The Super I/O RMEF 184 is connected to the internal LPC bus 179 similar to the real Super I/O function 66 shown in FIG. 1. The Super IO RMEF 184 also interfaces with the IMB 156 to enable local and remote setting and configuration. This RMEF enables remote connection of serial or parallel peripherals to the host over the management network 110. As there are no local serial or parallel connectors, the Super IO RMEF 184 provides the exact same set of registers and logic as the real Super IO but instead of connecting to local peripherals it stream the data IO over IP to the remote management console/application.

The Management CPU function 178 is a low power typically RISC architecture processor that manage and control the whole Emulated south-side sub-system 150. This processor runs a code initially stored on a non-volatile memory space (typically flash based) 182. It also uses a volatile memory space such as RAM or SRAM 180. The Management CPU function 178 typically comprised of an integrated bus interface to enable interface with the IMB 156 and an integrated memory controller to interface with the memory 180. Depending on the implementation details the flash function 182 may interface with the Management CPU 178 through the IMB 156 or through a dedicated interface bus and signals.

Typically the Management CPU 178 and the entire Emulated south-side sub-system 150 components are designed for low power operation to enable efficient use when the host is in off state, failed or malfunctioned. Local power supply function 176 responsible for providing power to the Emulated south-side sub-system 150, typically with the host power supplies 83 as the primary power sources. When the host power supplies 83 are off there is still an always on power plane that may power the Emulated south-side sub-system 150 circuitry through the local power supplies 176. In case that host power is not available at all, the local power supply may still operate through power over Ethernet function 174 or through local battery (not shown here). The power over Ethernet (PoE) function 174 extracts power from the management LAN to enable Emulated south-side sub-system 150 operation during power out states. It typically connects to the management LAN interface 172 magnetics to receive power carried between the TX and RX LAN wires or through unused wire pairs.

The Management LAN interface function 172 interfaces between the IMB 156 and the management LAN 110. It is typically comprises of a 10/100 Mbps Media Access Controller (MAC), a Physical Layer circuitry and LAN magnetics to provide matching and isolation.

An optional Crypto Processor function 183 may be added on the IMB 145 to augment the CPU function 178 in complex operations that may be needed for management traffic encryption/decryption and authentications. This function may be adapted to accelerate SSL, IPSEC, DES, 3DES, AES, RING etc.

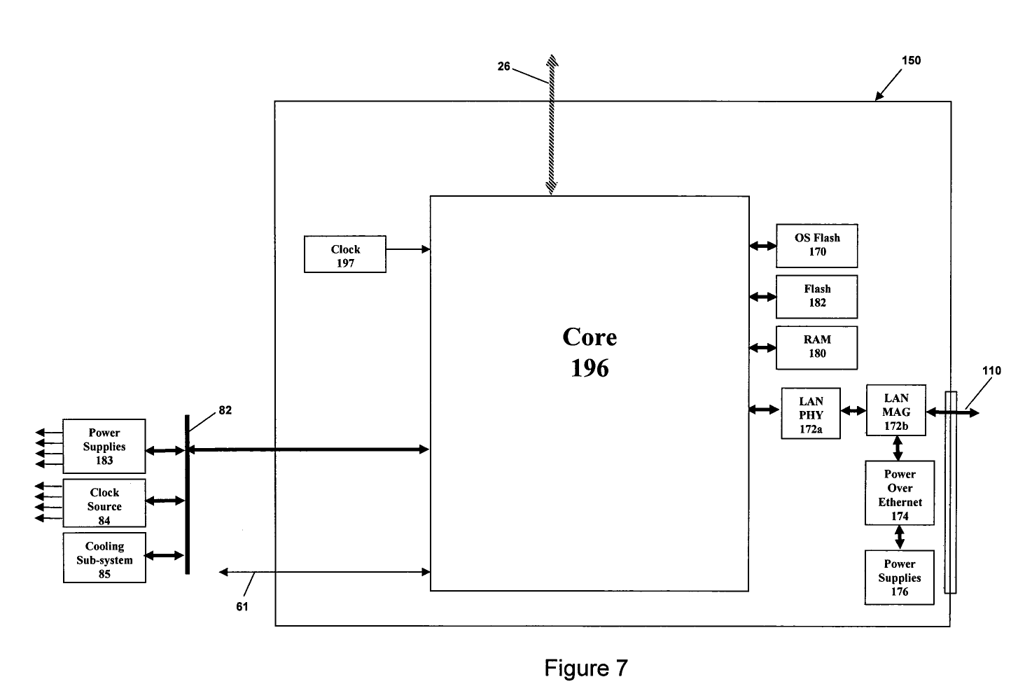

FIG. 7 illustrates a block diagram of a possible implementation of the Emulated server south side sub-system embodiment. This implementation uses a single chip core 196 to integrate most of the said RMEF and controller functions described in FIG. 6 above. This core 196 may be implemented using Field Programmable Gate Array (FPGA) or Application Specific Integrated Circuit (ASIC), Multi Chip Module (MCM) or any other suitable chip build technology.

Components that are not suitable for integration in the digital core 196 may be connected as external components to reduce core complexity and cost. These external components typically include the optional OS flash 170, the Flash 182, the RAM 180, the analog parts of the management LAN interface—the LAN PHY 172a and LAN magnetics 172b, the power supplies 176 and the Power Over Ethernet function 174. Additional support circuitry such as reset generation and main clock 197 may or may not be integrated in the core 196 depending on the specific design.

This type of implementation reduces the complexity, the size and cost of the server embodiment and provides a secured remote access to that server without the need to KVM specific components.

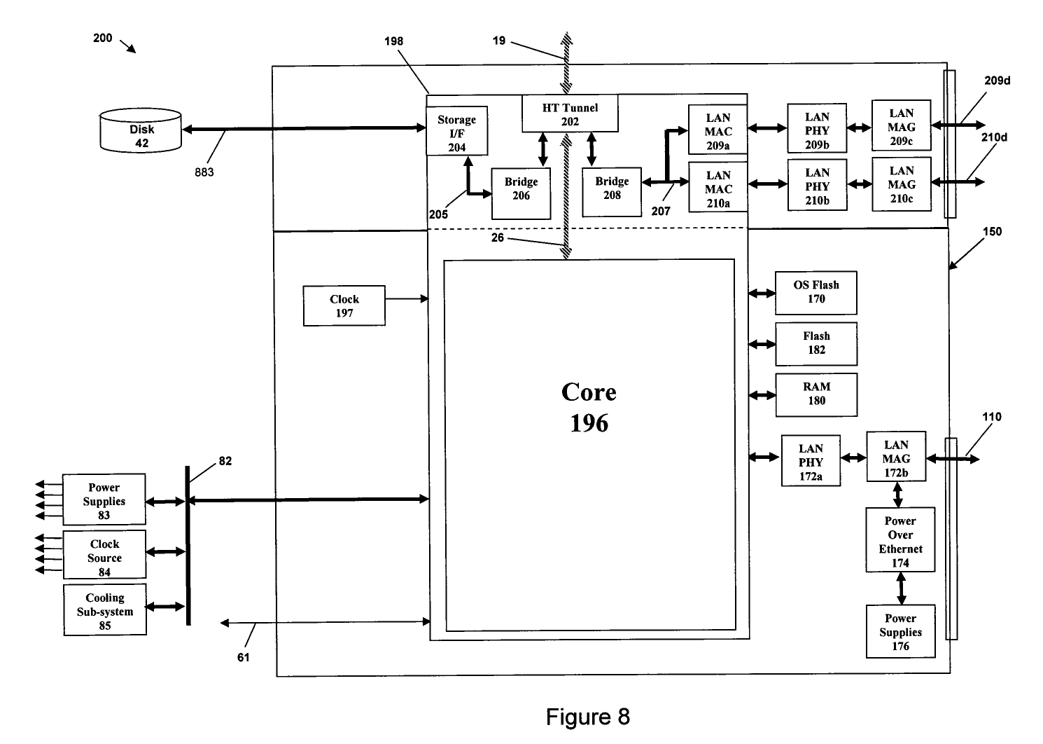

FIG. 8 illustrates a simplified block diagram of yet another embodiment of the present invention having the Emulated server south side sub-system integrated with the Hyper-Transport Tunnel and PCI-X or PCI Express bridge circuitry 200 on the same chip. In this embodiment the combined core chip 198, comprises of the same functions as core 196 described in FIG. 7 above and the additional functions of Hyper-Transport tunnel 202, two Hyper-Transport to PCI-X or PCI Express bridges 206 and 208, Storage interface 204 and two LAN MACs 209a and 210a.

I/O Chain non-coherent Hyper-Transport bus 19 couples the Hyper-Transport Tunnel 202 of the integrated Emulated server south side sub-system to the host. The Hyper-Transport Tunnel 202 further connected to two symmetric Hyper-Transport to PCI-X or PCI Express bridges 206 and 208 to interface the two connected PCI-X or PCI Express busses 205 and 207 respectively.

The PCI-X or PCI Express bus 205 couples with an integrated storage interface function 204 to enable connection of external or internal disks 24. Disk interface may be IDE, EIDE, PATA, SATA, SCSI, RAID, Fiber Channel or any other suitable disk interface technology.

The second PCI-X or PCI Express bus 27 is coupled with two integrated LAN MACs 209a and 210a. These MACs are typically Giga LAN or higher.

MAC 209a is coupled with external LAN PHY 209b and the PHY is coupled to the LAN magnetics 209c that interfaces with external LAN cabling 209d.

MAC 210a is coupled with external LAN PHY 210b and the PHY is coupled to the LAN magnetics 210c that interfaces with external LAN cabling 210d.

The PHY functions may be implemented internally on the core chip 198 to reduce external components needed.

Hyper-Transport tunnel 202 also coupled with a down stream Hyper-Transport bus segment 26 that interfaces with the Emulated South-side function Hyper-Transport cave 152 showed in FIG. 3 above.

This higher integration further reduces the server chipset parts count, reduces the cost and size of this server and improves its manageability and reliability. The integration of the emulated functions into a single chip 198 with the real functions such as LAN and storage interfaces is efficient in terms of I/O pin count as emulated functions are narrowed into a single management LAN interface with just a few I/O lines.

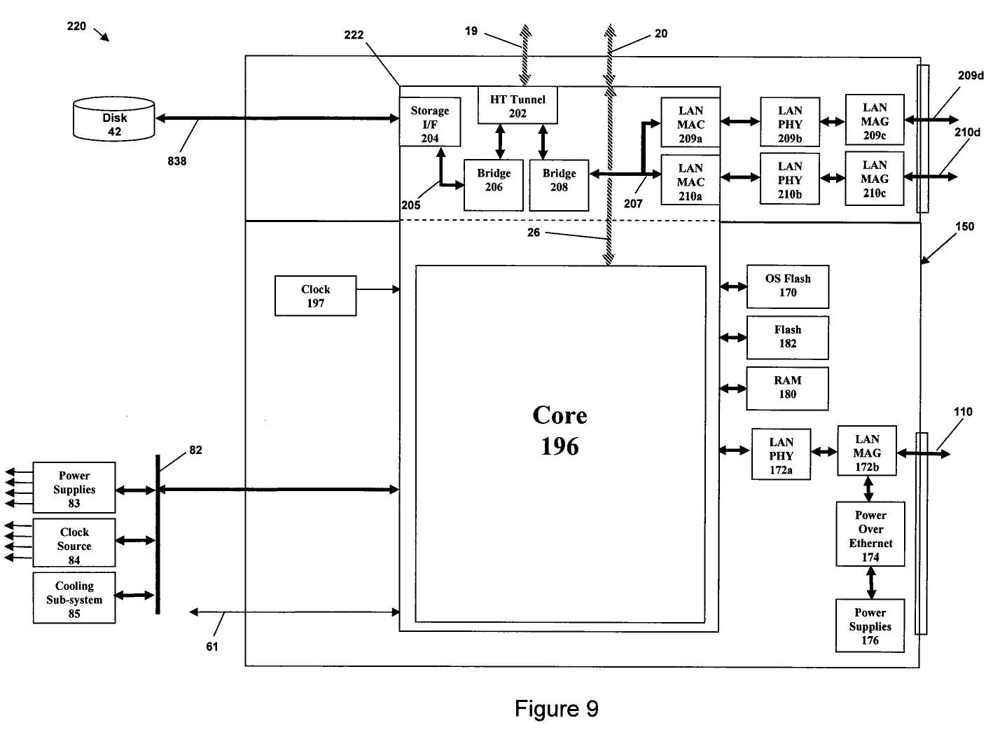

FIG. 9 illustrates a simplified block diagram of yet another embodiment of the present invention having the Emulated server south side sub-system integrated inside the Hyper-Transport Tunnel and PCI-X or PCI Express bridge circuitry 220. This embodiment intended for two or more processors server.

In this embodiment there are two Hyper-Transport links 19 and 20 connected to the integrated core chip 222.

Hyper-Transport tunnel 202 is coupled to one host node through Hyper-Transport link 19 to connect PCI-X or PCI Express bridges 206 and 208.

Hyper-Transport link 26 connected internally to the South-side emulator sub-system is coupled to another host node through Hyper-Transport link 20.

This arrangement enables LAN and storage accesses to pass through Hyper-Transport link 19 while slower I/O such as BIOS, USB, video etc. to pass through another Hyper-Transport link 20.

This implementation is particularly suitable for large multi-processor systems having a “ladder” topology with 6 or 8 processors with coherent Hyper-Transport cross links.

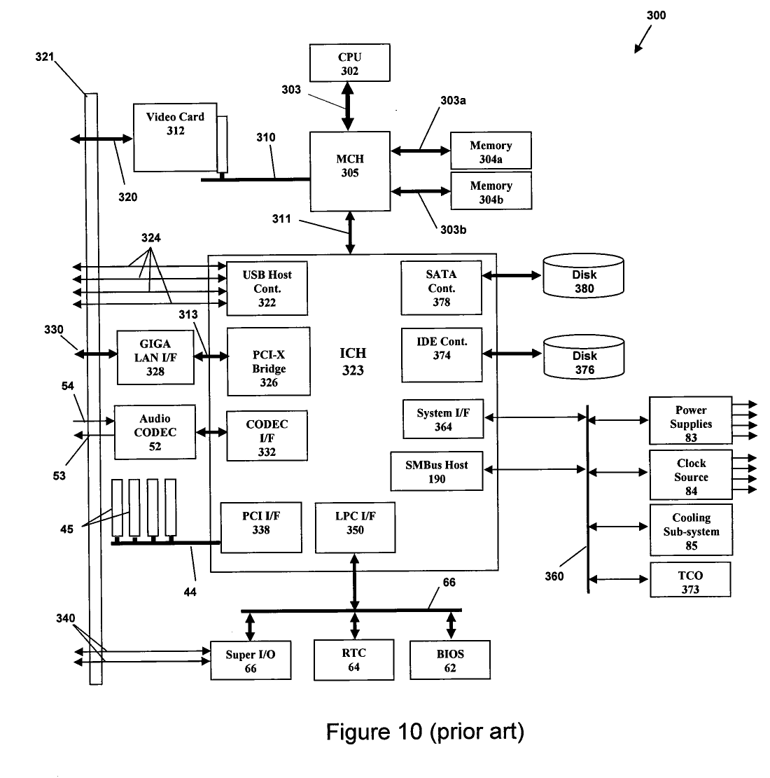

FIG. 10 illustrates yet another prior art server apparatus 300 block diagram having an Intel architecture with single processor.

Processor (CPU) 302 processes the data to perform useful server tasks and run various programs. The CPU 302 typically contains on-chip L2 cache to improve memory usage performance. The Front Side Bus (FSB) 303 interconnects the said processor (CPU) 302 and the Memory Control Hub (MCH) 305 that serves as the North Bridge. The FSB 303 is typically a 64 bit data and 32 bit address running at 400 MHz to 1.2 GHz clock. The MCH 305 interfaces between the CPU and the two channels of memory—Memory channel A 303a and Memory channel B 303b to enable access memory banks—Memory A 304a and Memory B 304b respectively. Each memory channel is typically 64 data bits with 8 bit Error Correction (ECC), 13 bit of address and various other control and clock signals to interface with Dual Data Rate (DDR) memory chips. The MCH 305 also bridges between the CPU 302 and the PCI-X or PCI Express graphics video card bus 310 to interface with the PCI-X or PCI Express video card 312. The said video card 312 connected to local display via analog or digital Video interface for display 320 that extends through the server system Chassis 321.

Direct Media Interface (DMI) or Enterprise South Bridge Interface (ESI) 311 interconnects the MCH 305 and the I/O and control functions at the I/O Controller Hub (ICH) 323. The DMI/ESI developed by Intel to meet the I/O device-to-memory bandwidth requirements of PCI-X, PCI Express, PCIe, SATA, USB 2.0, High Definition (HD) Audio and others. It is a proprietary serial interface, based on PCIe. This link offers 2 GB/s maximum bandwidth. The DMI/ESI integrates priority-based servicing to allow concurrent traffic and isochronous data transfer capabilities for HD Audio Codec. DMI is comprises of 4 differential Transmit pairs, 4 differential Receive pairs and various control signals. ESI is based on similar transmit/receive pairs as DMI but with additional clock pair.

The I/O functions attached to the DMI/ESI link 311 including:
USB Host controller 322 to enable local connection of various USB 2.0 devices through USB Ports 324;
PCI Express or PCI-X Bridge 326 to connect fast PCI Express or PCI-X I/O cards such as Giga LAN Controller 328 that interfaces with the System Giga LAN 330. The PCI Express or PCI-X Bus 313 is a 64 bit bus running at clock rates that may vary from 66 MHz single clock to 133 MHz quad clock (533 MHz) delivering data throughputs of 533 MB/s to 4.26 GB/s.
CODEC Interface 54 typically implemented using AC 97 serial link to drive Audio CODEC 334. Audio inputs and outputs 336 enable local connection of microphone, headset and speakers. Audio codec may be High Definition (HD) although high quality audio is not typically required in servers.
Legacy PCI Interface 338 interfaces with external PCI Bus 44 and PCI Slots 45 to enable installation of various legacy PCI cards. In smaller servers enclosed in 1U or 2U rack mounted enclosure these cards typically connected in parallel to the motherboard on a riser card. In recent years the use of PCI in server reduced to management cards and KVMs only and therefore the number of slots reduced to no more than one or two.
Low Pin Count (LPC) Interface 350 interfaces with external LPC Bus 179 to couple slower peripheral functions such as:
   Super I/O chip 66 that interface with legacy serial, parallel, floppy and PS/2 ports 44.
   Real Time Clock function 64 to keep date and time information and generate periodic interrupts.
   BIOS function 62 to store the initialization and power up programs on programmable flash memory space.
SMBus Interface 190 and System I/F 364 interface via System busses and signals 360 between the hxost and various system resources such as:
   Power supplies 83 that supplies stabilized DC voltages to power all system components;
   Clock source 84 that generates the various accurate clock signals required by various system components;
   and Cooling sub-system 85 comprising of sensors, fans, pumps and other components used to thermally monitor and cool various hot system components.
System Total Cost of Ownership (TCO) reduction circuitry 373. These ICH system management functions are designed to report errors, diagnose the system, and recover from system lockups without the aid of an external microcontroller.
   TCO Timer—The ICH's integrated programmable TC0 Timer is used to detect system locks. The first expiration of the timer generates an SMI# that the system can use to recover from a software lock. The second expiration of the timer causes a system reset to recover from a hardware lock.
   Processor Present Indicator—The ICH looks for the processor to fetch the first instruction after reset. If the processor does not fetch the first instruction, the ICH will reboot the system at the safe-mode frequency multiplier.
   ECC Error Reporting—When detecting an ECC error, the host controller has the ability to send one of several messages to the ICH. The host controller can instruct the ICH to generate either an SMI#, NMI, SERR#, or TCO interrupt.
   Function Disable—The ICH provides the ability to disable the following functions: AC'97 Modem, AC'97 Audio, IDE, USB, or SMBus. Once disabled, these functions no longer decode I/O, memory, or PCI configuration space. Also, no interrupts or power management events are generated from the disable functions.
   Intruder Detect—The ICH provides an input signal (INTRUDER#) that can be attached to a switch that is activated by the system case being opened. The ICH can be programmed to generate an SMI# or TCO interrupt due to an active INTRUDER# signal.
   SMBus—The ICH integrates an SMBus controller that provides an interface to manage peripherals (e.g., serial presence detection (SPD) or RIMMs and thermal sensors).
   Alert-On-LAN—The ICH may support Alert-On-LAN. In response to a TCO event (intruder detect, thermal event, processor not booting) the ICH sends a message over the SMBus. A LAN controller can decode this SMBus message and send a message over the network to alert the network manager.
IDE Controller 374 interfaces with local IDE disks 376 to read and write stored data.
Serial ATA (SATA) Controller 378 interfaces with SATA disks 380 to read and write stored data.

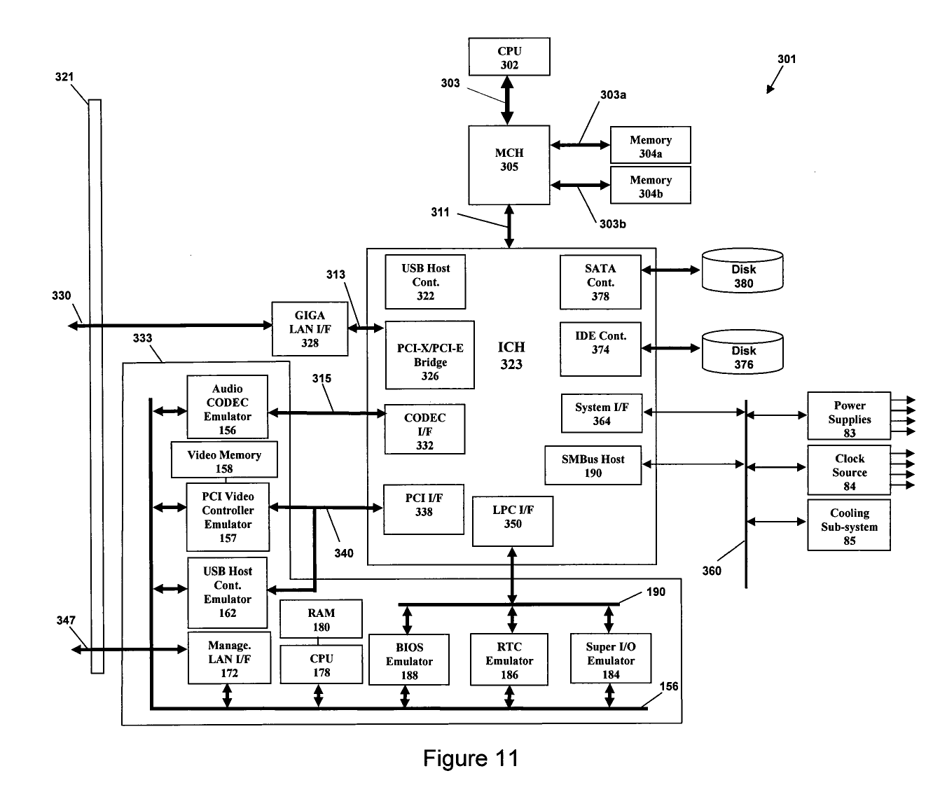

FIG. 11 illustrates a server 301 block-diagram similar to the prior-art single CPU server showed in FIG. 10 above wherein this server embodiment practicing the architecture of the present invention. In this server apparatus the South-side emulation circuitry is coupled to the prior-art ICH chip 323 externally. It should be noted that with some minor changes similar architecture can be used to support other chipset architectures and dual or multiple CPU topologies.

In this server implementation 301 various real functions were replaced by the South Side emulator block 333 to enable secured remote management and monitoring through the management LAN 347.

USB Host controller 322 of server 300 in FIG. 10 residing in ICH chip 323 is not in use in this architecture to enable remote USB connection. Instead there is a USB Host Controller RMEF 162 connected on the PCI bus 44. This RMEF emulates the standard USB host controller to the cores connected to the PCI side, while providing remote USB connectivity though the management LAN 347.

Similarly Audio CODEC 52 of server 300 in FIG. 10 replaced by Audio CODEC RMEF 156 to enable remote audio connection though the management LAN 347.

Similarly PCI-X or PCI Express video controller card 312 of server 300 in FIG. 10 replaced by PCI Video Controller RMEF 157 connected on the PCI bus 44 to enable remote display capability though the management LAN 347.

Similarly BIOS 62 of server 300 in FIG. 10 replaced by BIOS RMEF 188 to provide BIOS POST (Power On Self Test), boot and other services to the hostis. The BIOS RMEF 188 coupled to the IMB 156 to enable remote monitoring, configuration and upgrade of the BIOS though the management LAN 347.

Similarly RTC function 64 of server 300 in FIG. 10 replaced by RTC RMEF 186 to provide real time and date for the host/hosts. This RTC RMEF 186 coupled to the IMB 156 to enable remote monitoring, and setting of the RTC though the management LAN 347.

Similarly the Super I/O function 66 of server 300 in FIG. 10 replaced by a Super I/O RMEF 184. External ports 44 removed and the RMEF coupled to the IMB 156 to enable remote connection of legacy I/O devices through the management LAN 347.

The IMB 156 located at the South Side emulator block 333 connecting the various RMEFs to the management CPU 178, the management LAN interface 172 to enable remote management functions through management LAN 347 remote console/application.

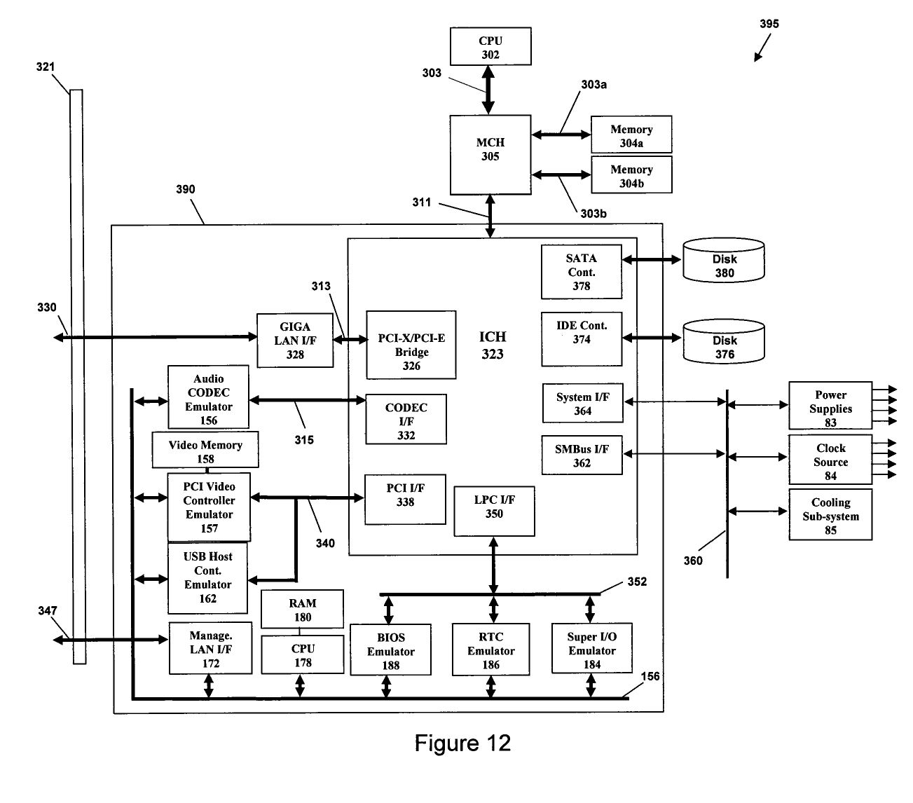

FIG. 12—illustrates a server 395 block-diagram according to the present invention similar to the single CPU server shown in FIG. 11 above wherein this server implementation having south side emulator functions 333 fully integrated with the ICH functions 323 in a single chip 390.

The ICH USB Host controller function 322 of FIG. 11 was removed to be replaced by USB-Host Controller RMEF 162. The System Interface function 190 and SMBus controller 190 connected to the IMB 156 to enable local and remote management functions.

This single chip integration offers reduced number of server components and therefore reduced costs and size. It also does not require any additional management cards or KVM to enable full remote management.

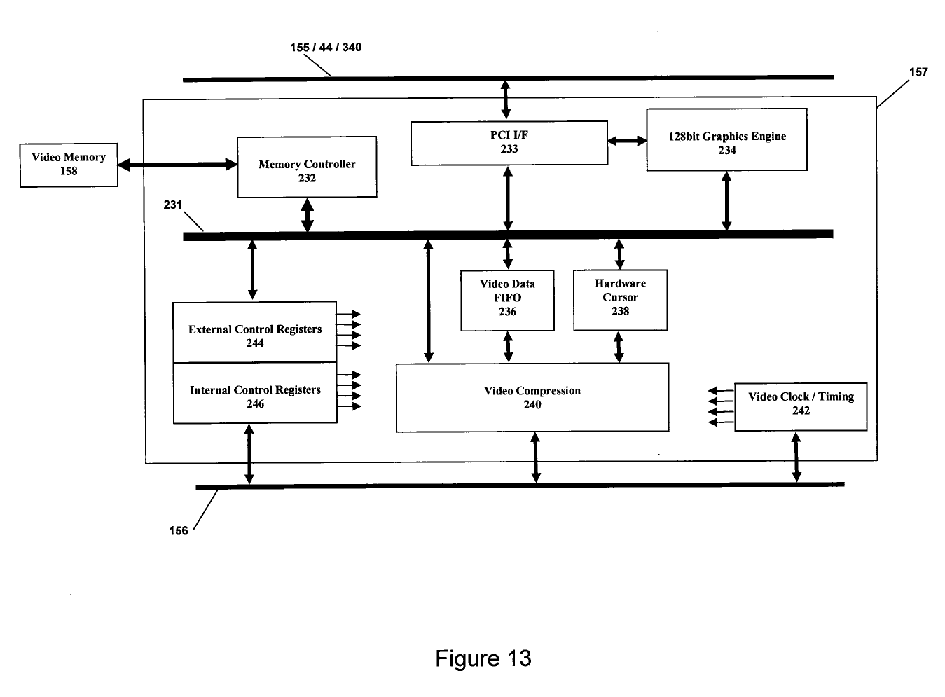

FIG. 13 illustrates a simplified block diagram of the Video Controller RMEF 157 of the present invention. This RMEF replaces the prior art local video controller function found in prior art servers.

PCI or PCI-X or PCI Express Interface 233 couples the RMEF 157 to the system PCI bus 155 to enable host access to the video controller resources. PCI or PCI-X or PCI Express Interface 233 may be configured as a PCI device or as a PCI bus master as necessary.

PCI or PCI-X or PCI Express Interface 233 is also coupled to the internal Video Controller RMEF bus 231. This bus is typically 64 or 128 bit wide to maximize video memory bandwidth. The internal RMEF bus 231 accepts video commands and data form the host through the PCI or PCI-X or PCI Express interface 233 and from the 128 bit graphics engine 234. The 128 bit graphics engine 234 is similar to standard server graphics engine with standard video BIOS registers, 2D video operations, windowing, text and drawing engines. The 128 bit graphics engine 234 accesses and manipulates the video (frame) memory 158 through the memory controller 232 coupled to the internal RMEF bus 231.

Two sets of registers are coupled together to maintain the various RMEF function settings. The External control registers 244 accessible to the host through the internal bus 231 and PCI or PCI-X or PCI Express interface 233. These registers may be monitored and manipulated remotely by the management console/application through the IMB 156. The Internal control registers 246 is only accessible to the management processor through the IMB and not to the host. This set of control registers may be used to define emulation specific parameters such as compression mode, compression quality etc.

The two sets of control registers may be connected to all other RMEF modules to control and monitor required functions.

Video data FIFO (First In First Out) buffer 236 is used to temporarily store frame data read from the video memory 158. FIFO is needed to assure constant and continuous flow of video frames data outside the RMEF through the optional Video Compression module 240 and IMB 156. As high-resolution high color depth and high-frame rates may generate very large amount of raw video data, video compression function may be added to compress this data on the fly. This module 240 get the uncompressed video data stream from Video Data FIFO 236 and applies predefined industry standard compression algorithm such as VNC or any other non-standard compression algorithm as necessary. Proper un-compression algorithm needs to be installed in the remote management console/application to enable video reconstruction and playing. Compression may be lossless or lossy as needed and depending on the actual network bandwidth available at the site.

Hardware cursor function 238 generates the required cursor graphic pattern (for example the mouse pointer) to be superimposed on the video frame stored in the Video data FIFO 236. Cursor location and characteristics may be controlled by the host through the internal bus 231 and the PCI or PCI-X or PCI Express bus interface 233. Cursor graphics may be stored locally at the Hardware cursor function 238 or at pre-defined area in the video memory 158. The video stream flow out of the video data FIFO 236 and the Hardware cursor video moved out of the Hardware cursor function 238 is synchronized and combined at the Video compression function input to create the required superposition effect.

Video clock and timing function 242 generates all synchronized clock outputs required for the operation of all other Video Controller RMEF functions. This function is controlled by the various External control registers 244 and Internal control registers 246. Video clock and timing function 242 also used to generate the horizontal and vertical sync signals required for compression along with the video streams.

Using industry standard protocols such as VESA DDC, remote console display type can be detected and transferred to the Video controller RMEF to enable automatic settings of transmitted video settings to match remote connected display.

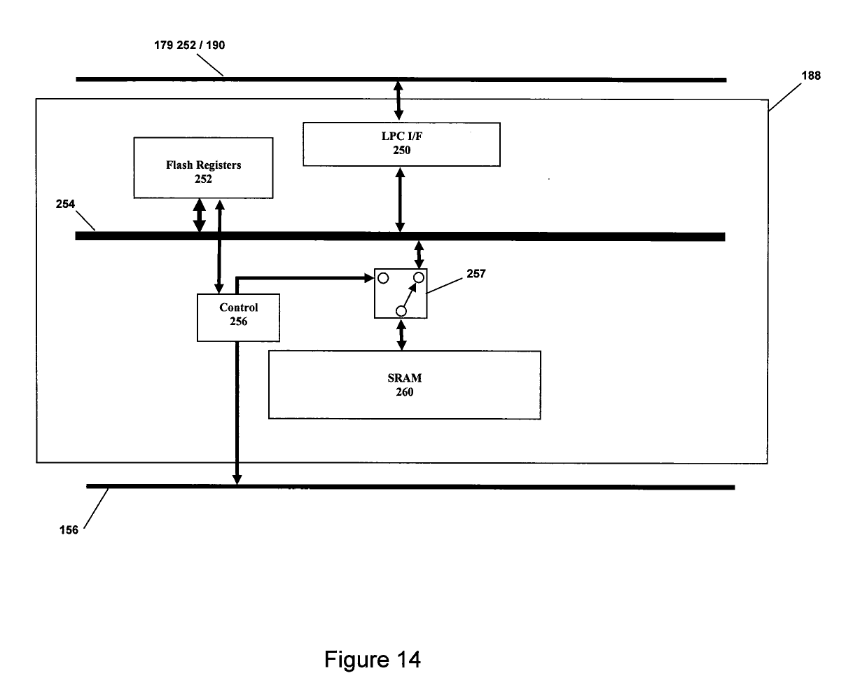

FIG. 14—Illustrates a more detailed block diagram of the BIOS RMEF 188 of the present invention shown in FIGS. 6, 11 and 12. This RMEF enables host read and write transactions that are identical to real flash transaction (or Firmware Hub standard FWH) using a volatile memory. This function is connected to the hostis through the LPC bus 179. LPC Bus interface 233 bridges between the LPC bus 179 and the internal bus 231. Internal bus 231 connected to an SRAM array 240 through a read/write logic 157. This logic enables the management processor to load the proper BIOS program and settings into the SRAM array 240 prior to host boot. Flash registers 232 used to emulate standard flash device registers and to control various read/write functions. Control function 240 manages and synchronizes the various read, write, control and erases transactions. BIOS image deployment and patching is performed from remote locations using the management LAN and the IMB 156 to load various code and settings into the SRAM array 240. Typically a local copy of the latest BIOS image is kept in the management computer non-volatile storage (such as flash storage 182 of FIG. 6).

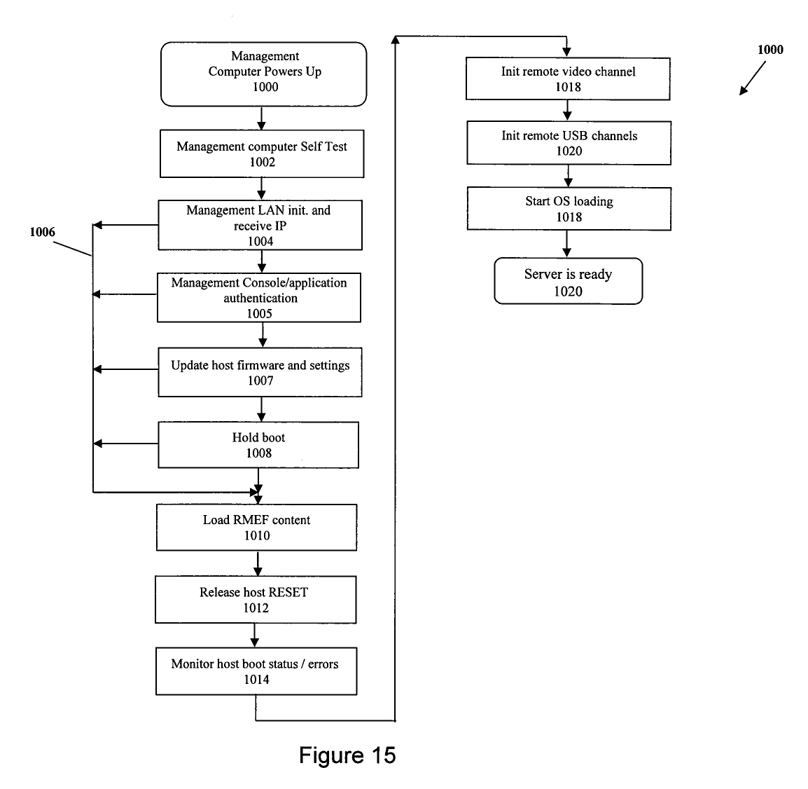

FIG. 15 is a flowchart illustrating a boot process of a server practicing the current invention.

This boot process will be better illustrated referring both FIG. 15 and FIG. 6.

When power first applied to the management power supply 176, it powers up the management CPU function 178 of FIG. 6. This step is shown in FIG. 15 as step 1000. Power may be available unrelated to the primary server power as power to the management function may be connected to a separate source.

As management CPU 178 of FIG. 6 is powering up, it performs self test and peripherals test to verify proper functionality and detect local configuration. Tests covering connected RAM 180, Flash 182 and all other accessible functions coupled to the IMB 156. This step is shown as 1002 in FIG. 15.

Upon successful test completion or if desired during the self-test, the management CPU 178 initializes the management LAN interface 172 and wait to receive IP address or set a static IP as configured. This step is shown as 1004 in FIG. 15.

If management CPU function 178 fails to initiate the management LAN 172, does not have LINK or fail to receive IP address, it switch to a local mode. This is shown in FIG. 15 as 1006.

Upon successful establishment of management network connection, the management CPU attempts to authenticate itself against the management console or management application. This bi-sided authentication is necessary to confirm that the managed server belongs to the group of manageable servers for that management console and application. From the other side, this authentication is essential for the managed server to assure that connected management platform or application is authorized to configure or monitor it. This authentication step is shown as 1005 in FIG. 15.

This authentication process may be assisted by the management crypto processor function 183 (shown in FIG. 6) that may support key exchange process and session encryption as needed.

At the next step (1007 in FIG. 15) the management CPU loads server configurations, policies and firmware updates if applicable from the remote management console or application. These will be loaded first into the management RAM 180 or flash 182 of FIG. 6.

If management console or application does not release or authorize the server boot, the management program will enter a hold state shown as step 1008 in FIG. 15. It will leave that state only upon instruction from the remote management console/application.

At any time after communication with remote management console/application established, the management CPU can monitor and report various server states and parameters through the coupled real functions such as the SMBus host controller 190 of FIG. 6 and the GPIO/PWM Controller 192 that connected to the server physical functions. These monitoring and reporting processes may be triggered by the management CPU at various intervals, upon triggering event such as after failure. It can also be initiated by the remote management console/application if desired.

As server boot is being released by the management console/application or if in local mode, the management CPU 178 will initialize load the latest content into the various RMEFs and real functions coupled to the IMB 156. This step is shown as 1010 in FIG. 15. At this step the proper time and date is loaded into the RTC RMEF and the proper BIOS image is loaded into the BIOS RMEF memory space to enable host BIOS use.

At the next step 1012 of FIG. 15, the management CPU will release the RESET input of the host to start the process of host reset.

During the host boot (step 1014 of FIG. 15) the management CPU monitors the various boot indications and progress and log it into its non-volatile memory or report to the remote management console/application.

If remote console is connected and set for remote shadowing, at the next step (1018 of FIG. 15) the management CPU will initialize a remote video session to the remote console. This video session can transmit the server video image generated in the Video Controller RMEF, to the remote console to enable remote interaction. Such interaction is complemented by remote USB link (step 1020 of FIG. 15) to enable connection of USB keyboard and mouse at the remote management console. It should be noted that video transmission can be compressed, encrypted and rescaled as necessary. It is also should be noted that video transmission may be available during host boot initial part as the remote video session may be initialize prior to the host boot.

The said remote USB connection also may also enable remote connection of USB storage devices in order to load and install various software applications on the host server.

As first host core finishes to execute POST and BIOS the host is ready for next core boot (if multi-core) or core will start in parallel loading Operating System as shown in FIG. 15 in step 1018. Operating system may be loaded from external storage device or array or may be loaded from internal storage as shown the server in FIG. 6 having optional OS flash 170.

At the end of this step the server will be ready to load the various installed applications—step 1020 in FIG. 15.

It should be noted that at any time during the boot process or after the boot, the remote management console/application may command host reset if needed.

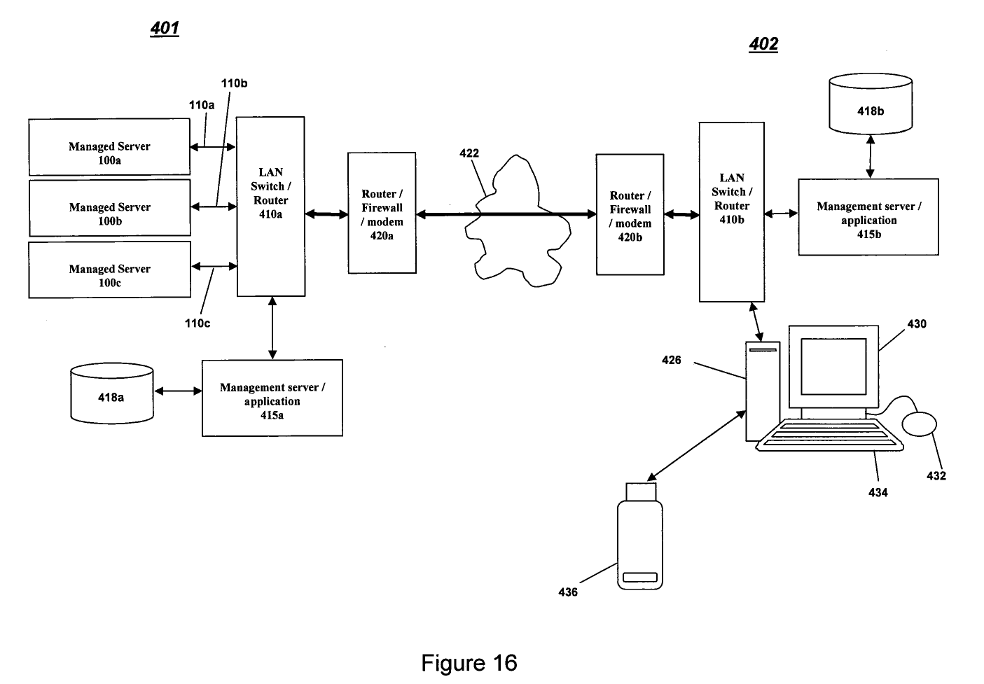

FIG. 16 illustrates a block diagram of a system 400 that utilizes the server architecture of the present invention. In this example, site 401 comprises of 3 managed servers of the present invention designated as 100a, 100b and 100c. Each one of these managed servers is connected through management LAN 110a, 110b and 110c respectively in addition to primary LAN and possibly storage interfaces (not shown in this figure). Management LAN is connected to a LAN switch or router 410a to enable centralized management access to the 3 local servers. Access to that management LAN can be local if administrators and management applications are local or remote if administration is done remotely. Remote management may be the most efficient solution in case that site 401 is a branch with local servers while multiple branches such as 401 are centrally managed from one (or more) locations 402. In the case of local management the Management LAN may be connected to a local management console (not shown) or management application residing on local server 415a. The server 415a is coupled to database 418a that stores various operational data such as: software components for deployment to servers, server status and event logs, server settings, policies etc. The management application residing at the server 415a monitors and controls the 3 on-site managed servers 100a, 100b and 100c.

Router, Firewall, VPN or modem 420a couples the management LAN switch 410a to the Wide Area Network (WAN) 422. This WAN connected to remote site 402 through another Router, Firewall, VPN or modem 420b and LAN switch or router 410b. Administrator's management console computer 426 enables remote connection to each one of the 3 servers 100a, 100b and 100c located remotely at site 401. Using the management function of the managed servers, administrator at site 402 can see video images transmitted from the said servers Video Controller RMEF on the management console display 430. Management console may be a local application installed on the computer 426 or web browser that connects to the said servers using loadable viewers such as Active-X or JAVA components. Administrator's keyboard 434 may be linked to the managed server using the server management LAN and the USB Host controller RMEF. Similarly administrator's mouse 432 may be linked to the managed server to enable interaction, installation and monitoring.

Storage device 436 may be connected by the administrator to the management console computer 426 to enable data upload or download to the managed remote server. Such storage device 436 may be CD drive, DVD drive, hard-disk, flash drive etc.

Management server 415b and management database 418b located at site 402 are similar to server 415a and database 418a located locally at site 401. This may serve as a centralized management function for multiple remote sites like 401.

Different security schemes may be used to enable secured management functions. This may include multiple administrative permission levels centrally defined in management tree, administrator authentication, session encryption, use of firewalls and VPNs, server authentication and many other security options to protect this critical function from internal or external threats.

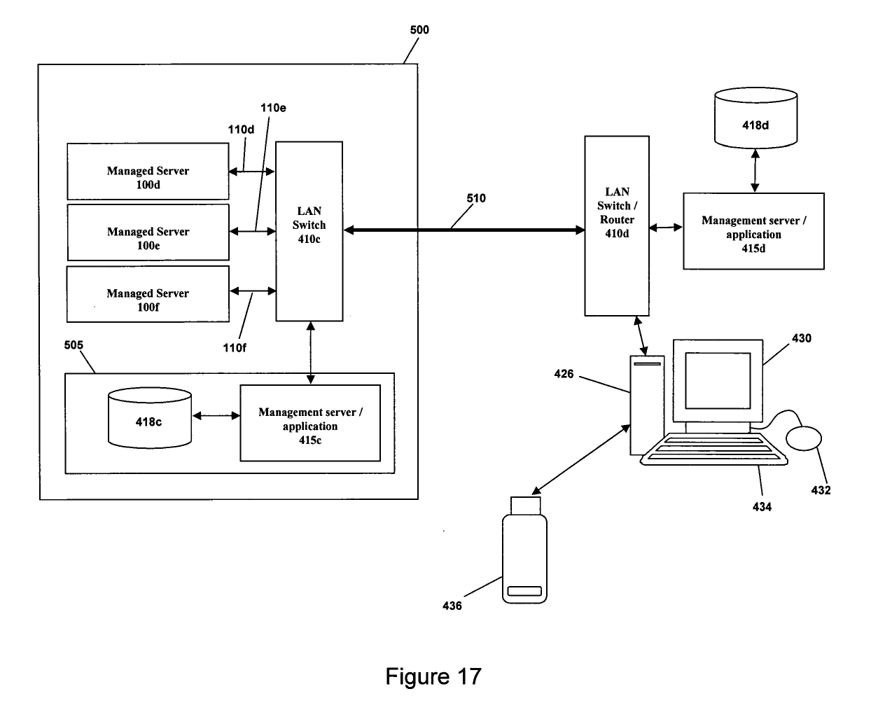

FIG. 17 illustrating a block diagram of yet another implementation of the present invention having a blade or 3DMC server 500. This blade or 3DMC server 500 comprises of multiple managed server blades or cells 100d, 100e and 100f connected to a backplane through management LAN 110d, 110e and 110f respectively. Blades or cells are typically connected to additional services such as power, primary LAN and storage (not shown here). Blade or 3DMC server also typically having a LAN switch module 410c to consolidate multiple management LAN connections from multiple blades or cells. LAN switch connected to external management LAN port 510 to enable administrative and management tasks.

Optional management blade 505 comprises from similar managed server 415c or degraded special purpose core. Internal database 418c in the form of local disk or flash storage may be installed to store local software components and settings of the managed blades or 3DMC cells.

Administrator may interact with the managed servers using similar management console computer 426 as shown in FIG. 16 above. Similarly management server and application 415d may be used to manage said server blades or cells.

While the invention has been described with reference to certain exemplary embodiments, various modifications will be readily apparent to and may be readily accomplished by persons skilled in the art without departing from the spirit and scope of the above teachings.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. The terms “comprise”, “include” and their conjugates as used herein mean “include but are not necessarily limited to”

1. A server comprising:
at least one server core, wherein said at least one core comprises:
at least one central processing unit capable of processing digital data;
cache memory for providing said at least one central processing unit with fast memory data access;
volatile memory for temporarily storing data for said at least one central processing unit access;
and north-bridge capable of bridging said at least one central processing unit to said volatile memory and to an I/O;
at least one storage interface I/O function;
at least one local area network interface I/O function;
remote graphic controller manageable emulated function (RMEF) comprising:
circuitry capable of emulating a standard graphic controller to said at least one core so as to enable said at least one core to generation of video frames;
circuitry capable of remotely delivering said video frames to remote management console application.

2. The server as claimed in claim 1 wherein said remote graphic controller RMEF further comprises at least on 2D graphics engine, video data FIFO buffer, hardware cursor function, video clock, phase locked loops (PLLs) and timing functions and video memory capable of storing video frames wherein said video memory can be a shared or dedicated.

3. The server as claimed in claim 1 wherein said remote graphic controller RMEF further comprises at least one control registers such as external control register capable of being remotely managed by a console application or internal control register accessible to the remote management console application.

4. The server as claimed in claim 1 wherein said remote graphic controller RMEF further comprises video compression function for enabling video compression of transmitted remote video using common industry standards shadowing protocols such as VNC, RDP, RealVNC or MPEG video or proprietary protocol or adaptive compression based on available network characteristics.

5. The server as claimed in claim 1 further comprising an input device controller RMEF capable of emulating standard peripheral devices such as USB mouse, USB keyboard, USB mass-storage for said at least one server core, and having circuitry capable of interacting with said peripheral devices physically connected to remote management console.

6. The server as claimed in claim 1 further comprising a BIOS RMEF function enabling said at least one server core to boot from local stored programs located on memory media such as RAM, SRAM, dual port RAM, flash or any other suitable volatile or non-volatile memory media that is accessible by the remote console application for enabling remote BIOS configuration and BIOS program updates.

7. The server claimed in claim 1 further comprising an emulated audio CODEC RMEF emulating legacy audio CODEC such as AC-97 or high definition audio to said at least one server core while enabling remote audio interaction at the management console with plurality of connected audio peripherals such as microphones, headsets and speakers.

8. The server as claimed in claim 1 wherein the server further comprises a local mass storage emulation and local non-volatile function enabling local server boot and operating system loading.

9. The server as claimed in claim 1 further comprising a real time clock RMEF function capable of enabling said at least one server core to access time and date information locally while synchronizing said real time clock with external clock and date sources by the remote console application.

10. The server as claimed in claim 1 further comprising at least one legacy logic RMEF function capable of enabling said at least one server core to access various legacy x86 functions such as interrupt controller, DMA controller, programmable interval timer, capable of being remotely manageable by the remote console application.

11. The server as claimed in claims 1 wherein the RMEF connection to the remote console application is operable by one or more methods selectable from: sharing with the server core, primary LAN interface, independent management interface and management LAN or WAN.

12. The server as claimed in claims 11, wherein the RMEF connection to the remote console application is further secured by one of the following methods: encryption, IPSec, PKI authentication, random number generation.

13. The server as claimed in claim 1, wherein the RMEF is controlled by a dedicated management microprocessor coupled with volatile and non-volatile memory, remotely accessible by one of the following methods: standard web browser, simple network management protocol (SNMP), common management agents such as HP OpenView, Tivolli, Calif. Unicenter, Altiris, VMware, Microsoft SMS.

14. The server as claimed in claim 13 wherein said dedicated management microprocessor can detect server cores CPU type, VRM setting, memory information and other components identification capable of logging, monitoring and configuration function.

15. The server as claimed in claim 13 wherein said dedicated management microprocessor performs server and management events logging using said local non-volatile memory and remote management application.

16. The server as claimed in claim 1, wherein the RMEF is coupled to an internal management bus (IMB) to enable remote connectivity and monitoring through a connected management LAN interface.

17. The server as claimed in claim 16, wherein the RMEF, the IMB, management LAN interface and management processor are powered by a separate power source operable in one or more of the following modes: always-on (to assure proper management and monitoring while main server power supplies are turned off or when server resets), power over Ethernet (POE) circuitry (to power it from remote power source equipment or power injector), local battery or capacitor.

18. The server as claimed in claim 1 wherein at least two of the RMEF functions are included in a single chip or module having various external circuitries such as LAN physical layer, volatile memory and non-volatile memory.

19. The server as claimed in claim 18 wherein said single chip further comprises at least one server core interface or north bridge interface protocols such as: HyperTransprt, PCI, PCI-X, PCI Express, Intel's Hublink, Intel's Direct Media Interface (DMI) or proprietary protocols.

20. The server as claimed in claim 18 wherein said single chip further comprises at least one server control and monitoring functions such as: SMBus host controller capable of controlling and monitoring plurality of server functions such as cooling system, clocks, power supply, switches, thermal sensors etc, thermal trip switches, core reset, power OK signals, and chassis tamper detectors, pulse width modulation controller capable of controlling plurality of server functions such as cooling system, fans, and power supplies, Analog to Digital function capable of remotely monitoring server analog parameters such as supply voltages and currents, frequency sense function capable of enabling locally and remotely monitoring server essential functions such as fan tachometers or cooling fluid flow rate.

21. The server as claimed in claim 18 wherein said single chip comprises at least one server function such as server primary LAN interface, server storage interface, HyperTransport tunnels or HyperTransport Bridges to interface with plurality of peripheral functions through PCI, PCI-X, PCI-Express or other protocol.

22. A server comprising:
at least one server core comprising:
at least one central processing unit capable of processing digital data;
cache memory for providing said at least one central processing unit with fast memory data access;
volatile memory capable of temporarily storing data for said at least one central processing unit access;
north-bridge for bridging said at least one central processing unit to said volatile memory and to an I/O;
at least one storage interface I/O function;
at least one local area network interface I/O function;
remote manageable emulated functions (RMEF) implementing plurality of functions.

23. The server as claimed in claim 55, wherein said plurality of functions are at least one of function such as video controller, BIOS, USB controller, RTC, and legacy x86, and wherein the plurality of functions are remotely manageable through LAN.

24. The server as claimed in claim 55, wherein the RMEF is integrated with necessary interfaces for monitoring and controlling server's resources such as cooling, power, reset and intrusion detection.

25. The server as claimed in claim 55, wherein said at least one storage interface I/O function, at least one local area network interface I/O function, and the RMEF are integrated into a single chip or module with external circuitry.

26. The server as claimed in claim 55, wherein the server is capable of handling virtual machines by special handling of I/O requests.
